(19) United States
(12) Patent Application Publication
(10) Pub. No.: US 2022/0007624 A1
(43) Pub. Date: Jan. 13, 2022

(54) Multiple Head Fishing Lure System

(71) Applicant: Richard Winfrey, Iowa, LA (US)

(72) Inventor: Richard Winfrey, Iowa, LA (US)

(21) Appl. No.: 17/070,282

(22) Filed: Oct. 14, 2020

Related U.S. Application Data
(60) Provisional application No. 63/049,204, filed on Jul. 8, 2020.

(51) Int. Cl. A01K 85/01; A01K 85/10; A01K 83/00

(52) U.S. Cl. CPC A01K 85/01; A01K 83/00; A01K 85/10

(57) ABSTRACT

The present invention relates to a fishing lure system for increasing the chances of catching fish. The fishing lure includes a number of fish molds or heads attached to a wire arm, with several of the fish molds having an LED feature and a spinner blade attached thereto. The presence of the LED fish molds and spinner blades in close proximity to one another when travelling through the water provide an illusion of a school of bait fish that will attract, and enable the angler to catch, a larger number of targeted fish and with greater frequency.

### CROSS-REFERENCE TO RELATED APPLICATION

The present application claims priority to, and the benefit of, U.S. Provisional Application No. 63/049,204, which was filed on Jul. 8, 2020 and is incorporated herein by reference in its entirety.

### FIELD OF THE INVENTION

The present invention relates generally to the field of fishing tackle or bait. More specifically, the present invention relates to an improved fishing lure that gives the illusion of a school of fish swimming via LED molds and spinner blades. Accordingly, the present specification makes specific reference thereto. Nonetheless, it is to be appreciated that aspects of the present invention are also equally applicable to other like applications, devices and methods of manufacture.

### BACKGROUND OF THE INVENTION

By way of background, fishing is a popular recreational activity enjoyed by millions of people worldwide. Although a large segment of the fishing population participates largely on a recreational level, it should be recognized that fishing is also one of the largest food-acquiring and producing industries in the world. Millions of tons of fish of all types are caught and processed annually to feed a large portion of the world's population. In addition, sport fishing has also gained significant popularity, and the sport has spawned many different tournaments pitting anglers and others against one another in an effort to win a prize. Regardless of the reason for fishing, people of all ages enjoy doing so in streams, rivers, lakes, bays, and oceans as the climate and seasons of the year permit.

When recreational or sport fishing, a fisherman may choose from a wide variety of lures and/or bait to attract fish including, without limitation, artificial bait, live bait and/or a combination of both. For example, live bait, such as nightcrawlers, insects, worms, maggots, and smaller bait fish may be attached on the end of a fishing hook or lure and used to attract and catch fish. However, when using live bait, the fisherman typically needs to impale the live bait on the hook or lure, thereby causing the bait to die relatively quickly. Once the live bait dies, it is incapable of independent movement and may lose its ability to attract and catch fish. Furthermore, live bait anglers may be limited to a single bait on a fishing line (e.g., by local fishing regulations, scarcity of live bait, etc.), thereby causing a smaller number of fish to inevitably be caught by anglers. Therefore, many anglers prefer to use artificial lures and/or bait over traditional live bait to attract and catch fish.

Existing artificial lures are typically comprised of a wire leader having a hook, a fish or other head portion and/or a spinner head to attract and catch fish. One type of artificial lure, commonly referred to as a “spinner bait”, has a streamlined glossy metal plate called a spinner blade attached to the tip of the wire frame, wherein the spinner blade rotates as the lure travels through the water to create the illusion of a baitfish to attract other fish towards the lure. Once the targeted fish are attracted to the lure, they will oftentimes strike or attempt to consume the lure and become trapped on the hook, whereby the fish may then be successfully reeled in by the angler. Unfortunately, such artificial lures do not always attract a large number of fish because the lure gives the appearance of a single baitfish, as opposed to a plurality of baitfish, thereby decreasing the odds that the angler will catch a fish on any particular cast. Additionally, such artificial fishing lures oftentimes do not accurately resemble a live baitfish or mimic the movements of a live baitfish, thereby further resulting in fewer strikes and reduced odds that the angler will catch a fish on any particular cast.

Therefore, there exists a long felt need in the art for an improved artificial lure that effectively attracts a larger number of fish and with greater frequency. There also exists a long felt need in the art for an improved artificial lure that does not require the presence of live bait, or the unpleasantness of having to place the live bait on the hook or lure. Additionally, there is a long felt need in the art for an improved artificial lure that accurately imitates the movement of live bait fish. Moreover, there is a long felt need in the art for an artificial lure comprising a greater number of spinner blades and hooks to increase the likelihood of attracting and catching fish, and that gives the illusion of the presence of a school of bait fish. Finally, there is a long felt need in the art for an improved artificial lure that is relatively inexpensive to manufacture, and that is safe and easy to use.

The triple header fishing bait of the present invention provides an improvement over conventional prior art artificial fishing lures through an effective method of attracting and catching a large number of fish by utilizing a combination of three LED fish molds or likenesses, and several spinner blades. The spinner blades and fish molds imitate the movement of a plurality of live bait fish in the water in close proximity to one another, thereby attracting more targeted fish to their location, and increasing the likelihood of the angler successfully catching the targeted fish.

In this manner, the novel multiple head artificial fishing lure of the present invention accomplishes all of the forgoing objectives, and provides a relatively easy, convenient and effective solution to enabling an angler to attract and catch a larger number of fish during a fishing session. The multiple head artificial fishing lure of the present invention is also user friendly, inasmuch as it does not require the angler to have to collect or purchase, transport and then utilize live bait, and encounter the inconvenience and messiness of the same.

### SUMMARY OF THE INVENTION

The following description presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, provides a multiple head artificial fishing lure. The multiple head artificial fishing lure preferably comprises a wire structure that connects up to four spinner blades, a double 2/0 hook covered with a spinner bait skirt, an optional treble hook and several (preferably three) LED fish molds or likenesses. The presence of the LED fish molds and spinner blades in close proximity to one another when travelling through the water (i.e., via trolling or reeling in of the lure by the angler) give an illusion of a school of bait fish that will attract, and enable the angler to catch, a larger number of targeted fish and with greater frequency. The LED fish molds may be connected to several of the spinner blades and/or hooks, thereby allowing the manufacturer to manipulate the appearance of the artificial lure to employ differing fishing strategies and/or target different species of fish.

In a further embodiment of the present invention, the triple header artificial fishing lure provides an angler with an effective method of attracting and catching a large number of fish with greater frequency. More specifically, the triple header artificial fishing lure of the present invention is comprised of a series of two LED fish molds or likenesses and several spinner blades in a forward position on the lure, and trailed by a third LED fish mold having a skirt and a hook for catching the targeted fish located at a back end or rear of the lure. The close proximity and positioning of the various spinner blades and fish molds imitate the movement of live bait fish in water, thereby giving the illusion of the presence of a plurality of bait fish and attracting the targeted fish to the lure.

In yet another embodiment of the present invention, a multiple head fishing lure is disclosed. The multiple head fishing lure is comprised of a wire structure bent to form a first arm and a second arm. Positioned along the first arm in spaced apart relationship are two LED fish molds connected to a spinner blade, and an LED fish mold connected with a spinner bait skirt and having at least one hook, and preferably a double or treble hook. Positioned along the second arm in spaced apart relationship are a small spinner blade connected to a large spinner blade, wherein the second arm is positioned at an angle of less than 90 degrees relative to the first arm.

In an alternative embodiment of the present invention, the triple header spinnerbait comprises larger LED fish molds and may include fish molds of different types to attract different species of fish, and increase the probability of catching the same. The innovative design is based on three LED fish molds along with multiple spinner blades that imitate the movement of actual bait fish and create an illusion of a plurality of live bait fish being present to attract the target fish.

In yet another embodiment of the present invention, a multiple head fishing lure is disclosed. The fishing lure comprises a bent wire frame having a first arm and a second arm; the first arm including two or more glowing fish molds connected with spinner blades and/or spinner bait skirts, a double hook attached to a lower end fish mold, a treble hook attached to one of the fish molds, and a double spinner blade structure attached to the second arm of the wire frame. The fish molds may be manufactured using a glowing resin, an LED disposed inside a silicone material or other encapsulant, or the like.

In a still further exemplary embodiment, a method of using a multiple head fishing, lure is disclosed and includes the steps of initially providing a multiple head fishing lure having a wire with a first end and a second end and first and second arms, wherein the second arm is disposed at an angle to the first arm that is 90 degrees or less. The fishing lure further includes a least a first and a second fish mold removably connected to one of the first and second arms, and the first and second fish molds including an LED feature. The fishing lure is then placed on an end of a fishing line operatively connected to a fishing pole, and is moved through the water to simulate a school of bait fish in an effort to attract a target species of fish.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the multiple head fishing lure of the present invention in accordance with the disclosed architecture;

FIG. 2 illustrates a perspective view of one potential embodiment of the double spinner blade attachment to the multiple head fishing lure of the present invention in accordance with the disclosed architecture;

FIG. 3 illustrates a perspective view of one potential embodiment of the fish mold with a spinner blade attached thereto of the multiple head fishing lure of the present invention in accordance with the disclosed architecture;

FIG. 4 illustrates a perspective view of one potential embodiment of the multiple head fishing lure of the present invention in use and in accordance with the disclosed architecture; and

FIG. 5 illustrates a perspective view of an alternative embodiment of the multiple head fishing lure of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved artificial fishing lure that effectively attracts a larger number of fish, and with greater frequency. There is also a long felt need in the art for an improved artificial fishing lure that does not require the presence of live bait, or the unpleasantness of having to place the live bait on the hook or lure. Additionally, there is a long felt need in the art for an improved artificial fishing lure that accurately imitates the movement of live bait fish as they travel through the water. Moreover, there is a long felt need in the art for an artificial fishing lure comprising a greater number of spinner blades and hooks in a unique organization to increase the likelihood of attracting and catching target fish, and that gives the illusion of the presence of a school of bait fish in close proximity to one another. Finally, there is a long felt need in the art for an improved artificial fishing lure that is relatively inexpensive to manufacture, and that is safe and easy to use.

The present invention, in one exemplary embodiment, is a triple header artificial fishing lure. The triple header lure comprises a wire structure connecting four spinner blades, a double 2/0 hook covered with a spinner bait skirt, an optional treble hook and several LED illuminated lures made in fish molds or likenesses. The LED fish lures and spinner blades provide the appearance of a school of bait fish in close proximity to one another, which attracts target fish and vastly improves the angler's chances of catching the same and with greater frequency. The molds can be connected to several of the spinner blades and/or hooks, thereby allowing the manufacturer or angler to manipulate the appearance of the triple header artificial fishing lure as needed or to target a specific species of fish. The triple header artificial fishing lure allows the individual angler or manufacturer to produce a lure with a different number of fish molds thereon, for example between 2 and 15, depending on the type of line being used, and the species of the target fish.

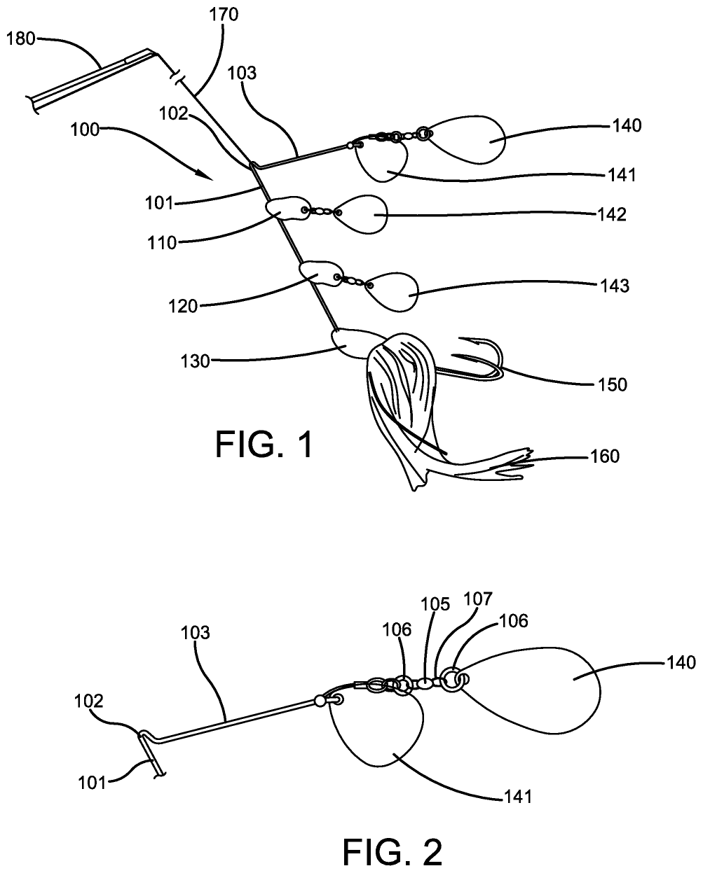

Referring initially to the drawings, FIG. 1 illustrates a perspective view of one potential embodiment of the multiple head fishing lure 100 of the present invention in accordance with the disclosed architecture. More specifically, fishing lure 100 is comprised of a wire structure that is made up of a first arm 101, a bent portion 102, and a second arm 103. The first arm 101, bent portion 102, and the second arm of wire 103 are preferably integrally formed from a single length of wire. Typically, the fishing wire is a single strand, stainless steel wire having a diameter that can range between 0.012″ to 0.05″, though the fishing lure 100 of the present invention is not necessarily limited thereby. There are generally three types of wire shafts used in fishing applications, namely closed loop, open loop and hook snap or safety pin. The wire shaft can be of any of the forgoing types and/or different shapes, and may further include ends with formed eyes, or have additional elements, such as swivels. For example, buzzbait shafts are typically used for dragging a lure along the surface of the water, and typically require a thicker wire. As best shown in FIG. 1, the second arm of wire 103 extends in a direction away from and generally perpendicular to the first arm of wire 101. More specifically, the angle of the second arm 103 relative to the first arm 101 is typically between 75 and 120 degrees, and more preferably less than 90 degrees.

In a preferred embodiment of the present invention, the fishing lure 100 is also comprised of a first fish mold or likeness 110, a second fish mold 120, a third fish mold 130, a first spinner blade 140, a second spinner blade 141, a third spinner blade 142, and a fourth spinner blade 143. The fish molds 110, 120, 130 of the present invention are meant to resemble live bait and may further comprise LED lighting or a fluorescent exterior surface. For example, the LED molds may flash during the angling event to attract the target fish. More specifically, waterproof and miniaturized LEDs may be used in the fish molds 110, 120, 130 that provide a light or glowing effect to attract and catch various species of fish. The LED lights can be set to flash intermittently at various intervals ranging from a fraction of a second between flashes to several seconds between flashes. The LED lights can also be set to remain illuminated, or be turned off altogether. Additionally, the LEDs inside the fish molds 110, 120, 130 may be of any color, such as red, yellow, blue, black, green, white, etc. Alternatively, the fish molds 110, 120, 130 may be manufactured using glowing resins or other materials which glow when submerged in water, and create the appearance of live bait fish. The resins or other materials may further comprise phosphorescent particles to enhance the glowing or illumination effect.

Additionally, the LED fish molds 110, 120, 130 may have an optical fiber head design that allows the light emanating therefrom to irradiate farther into the water to attract a larger number of target fish. In a further embodiment, the optical fibers may extend outwardly from the individual molds 110, 120 130 so that the lights can trail some distance behind the individual molds 110, 120, 130. The LED fish molds have a waterproof design, and can be used in the water depth of up to 100 meters.

As best shown in FIG. 1, the first, second and third fish molds 110, 120 130 are removably attached to the first arm in spaced apart fashion. Further, the third spinner blade 142 is removably connected to the first fish mold 110, and the fourth spinner blade 143 is removably connected to a second fish mold 120. The third fish mold 130 is also attached to a spinner bait skirt 160 and a double 2/0 hook 150. The elongated spinner bait skirt tail 160 is preferably comprised of relatively fine silicone tendrils and covers or conceals the double 2/0 hook 150. Notwithstanding, hook 150 can be any of a wide variety of different hooks including, without limitation, bait holder hooks, siwash hooks, Aberdeen hooks, circle hooks, octopus hooks, king Kahle hooks, shiner hooks, treble hooks, worm hooks, etc. Further, hook 150 may be removably attached to third fish mold so that the same can be interchanged with a different type of hook to suit user need and/or preference, or a particular application. Stated differently, by providing a system of interchangeable hooks and fish molds, the fishing lure system 100 can be modified as needed. The fishing lure 100 of the present invention is attached to an end of a fishing line 170 which is operative connected to a fishing pole 180.

The spinner bait skirt 160 is preferably 4-6 inches in length, and 1-2 inches in width with fused ends and a center portion slit into fine parallel tendrils. Nonetheless, the skirt 160 is also removably attached to the third fish mold 130 so that the angler (not shown) can personalize the fishing lure 100 to suit his or her needs and/or preference.

Each of the spinner blades 140, 141, 142, 143 is preferably comprised of a streamlined and glossy metal plate which may be attached to the fish molds 110, 120 or to the second arm 103 of the wire frame. The spinner blades 140, 141, 142, 143 rotate in the water to help create an illusion of a plurality of bait fish swimming in close proximity to one another to attract the target fish towards the lure 100. The spinner blades 140, 141, 142, 143 may have a variety of sizes, shapes, colors and finishes, and reflect the light from most of their surface. The first spinner blade 140 is preferably the largest of the spinner blades, though the sizes may vary to suit the user's needs and/or preferences. The spinner blades 140, 141, 142, 143 create varying degrees of flash and vibration that mimic the movements of bait fish, and the individual movement of spinner blades 140, 141, 142, 143 does not interfere with each other, thereby assuring that a relatively smooth movement of lure 100 in the water is achieved.

The double 2/0 hook 150 of the present invention maintains sharpness and strength. The hook 150 is relatively lightweight, and may have dimensions of approximately 4.4×2.2×1.1 inches. However, as previously stated, the hook 150 may vary by hook type, size, shape, etc. Further, hooks 150 may be manufactured from different materials including, without limitation, high-carbon steel, steel alloyed with vanadium, stainless steel or combinations thereof.

In use, the first arm 101 and the second arm 103 sway up and down and left and right as lure 100 is moving forward through the water (i.e., in three dimensions), which helps the fishing lure 100 appear like a randomly moving school of bait fish so that there is an increased chance of catching fish with greater frequency. Nonetheless, the movement of arms 101, 103 up and down is preferably limited to less than 180 degrees from the vertical, and the movement from left to right is preferably limited to a direction of travel of less than 160 degrees. Control of the movement can be through the use of the rod, skill of the angler, as well as the sizes of the spinners themselves. For example, larger spinners may be used to reduce the overall degree of movement, whereas smaller sized spinners will allow for a greater degree of movement. In addition, larger spinners will change directly less quickly than smaller spinners when used on the line.

FIG. 2 illustrates a perspective view of one potential embodiment of the double spinner blade attachment to the multiple head fishing lure 100 of the present invention in accordance with the disclosed architecture and attached to the second arm 103. More specifically, the position or orientation of the second arm 103 relative to the first arm 101 is preferably at an angle of 90 degrees or less. The second arm 103 is used to support each of the first spinner blade 140 and the second spinner blade 141, wherein the size of the first spinner blade 140 is preferably larger than the size of the second spinner blade 141. The first spinner blade 140 is removably connected to the second arm 103 using a spinner device loop 106, which is in turn attached to a rotatable swivel 105 and a snap ring 107. This connection leads to the swiveling or twisting effect of the first spinner blade 140 as it is being pulled, or otherwise moved, through the water.

As they move through the water, the spinner blades 140, 141 rotate regularly and continuously, and reflect sunlight and the light emanating or reflecting off of the various fish molds 110, 120, 130. This rotation, movement and reflection capability, combined with the movement of the fish molds and spinner blades attached thereto, provides the appearance of a school of bait fish and is used to attract the target fish towards the fishing lure 100. Additionally, the presence of fish molds 110 and 120 positioned ahead of spinner blades 142, 143 creates additional turbulence as the water passes over the molds 110, 120, thereby causing the spinner blades 142, 143 to twist more quickly. The use of different fishing mold designs can enable the angler to change the amount of turbulence directed at the spinner blades 142, 143 and affect their operation.

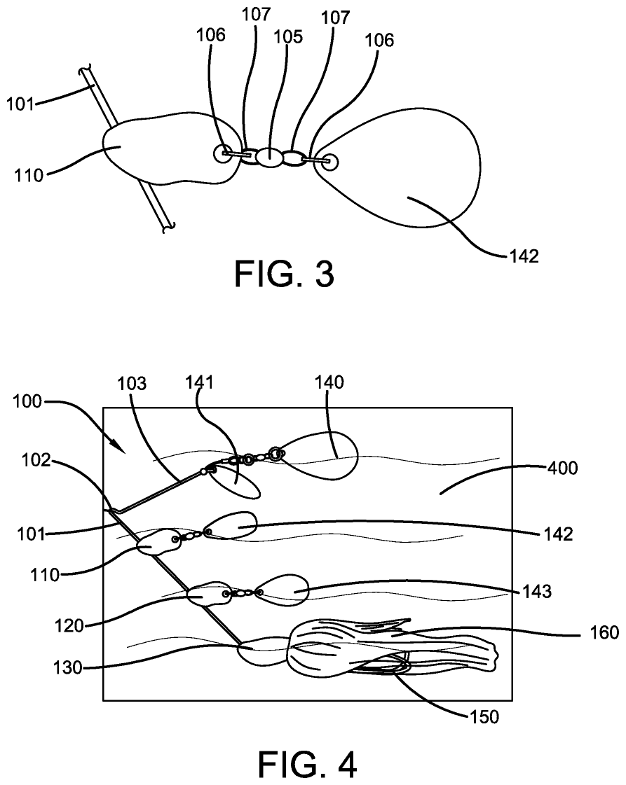

FIG. 3 illustrates a perspective view of one potential embodiment of the fish mold 110 with a spinner blade 142 attached thereto of the multiple head fishing lure 100 of the present invention in accordance with the disclosed architecture. More specifically, first fish mold 110 is removably attached to first arm 101, and a spinner device loop 106 is connected to a tail end of the first LED fish mold 110, which is further connected to a first snap ring 107. A rotatable swivel 105 is positioned between and connects the first snap ring 107 to a second snap ring 107, as best shown in FIG. 3. A narrower end of the third spinner blade 142 is then removably attached to the second snap ring 107 using a second instance of the spinner device loop 106. The particular orientation and attachment of the spinner blade 142 to the fish mold 110 using spinner device loops 106, snap rings 107, and rotatable swivel 105 provides a robust structure for the fishing lure 100. In a similar manner, the fourth spinner blade 143 is connected to the second LED fish mold 120.

FIG. 4 illustrates a perspective view of one potential embodiment of the multiple head fishing lure 100 of the present invention in use and in accordance with the disclosed architecture. More specifically, and as shown clearly, the orientation and features of the various components of fishing lure 100 provide the illusion of a school of bait fish, which enables an angler to use the fishing lure to attract and catch targeted fish in larger numbers, and with greater frequency. Further, the third LED fishing mold 130 is connected to the spinner bait skirt 150 which, in turn, helps to hide the presence of hook 150.

As also shown in FIG. 4, the second LED fishing mold 120 is connected to the fourth spinner blade 143, and the first LED fishing mold 110 is connected to the third spinner blade 142. The first spinner blade 140 and the second spinner blade 141 all mimic a school of small fish moving in a direction at different levels within the water 400. Accordingly, target fish swimming in the area within the water 400 will be attracted to the fishing lure 100, thereby increasing the angler's chances of success. As previously stated, spinner blades 140, 141, 142, 143 may have any shape including, without limitation Colorado, Indiana, fluted, turtle back, willow, inline, French and the like.

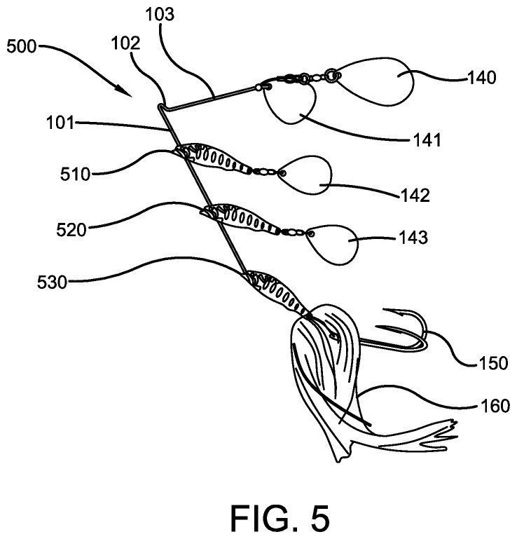

FIG. 5 illustrates a perspective view of an alternative embodiment of the multiple head fishing lure 500 of the present invention in accordance with the disclosed architecture. More specifically, to attract different types of target fish, different types of LED fish molds may be used. For example, to attract bigger fish, bigger LED fish molds 510, 520, 530 are used in a manner similar to those illustrated in FIG. 1. Various shapes of LED fish molds 510, 520, 530 may also be used to attract the target fish. For example, in various embodiments, goldfish-shaped head LED fish molds, salmon-shaped head LED fish molds, trout fish LED molds or other similar shaped LED fish molds may be used. In one embodiment, a treble hook or Double 2/0 hook may be attached to one or more of the LED fish molds 510, 520, 530 to catch multiple target fish at the same time. The size and shape of LED fish molds 510, 520, 530 may be the same or different as per requirements of the user for the particular application. The color of the LED module may also be the same or different across LED fish molds 510, 520, 530.

The treble hook 150 used in the invention preferably features three bends and barbs in one hook, and provides greater coverage for both artificial baits and natural baits. The hook size may vary from 1#(100PC) to 5/0#(50PC). For fishing hooks 150, generally the larger the number, the smaller the hook. Fishing hook sizes range from 32 (the smallest) to 1 (the largest).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “triple header”, “triple header fishing bait”, “triple header spinnerbait”, “triple header fishing lure”, “multiple head fishing lure” and “fishing lure” are interchangeable and refer to the triple header fishing lure 100 of the present invention.

Notwithstanding the forgoing, the triple header fishing lure 100 of the present invention and its various components can be of any suitable size and configuration as is known in the art without affecting the overall concept of the invention, provided that it accomplishes the above stated objectives. One of ordinary skill in the art will appreciate that the size, configuration and material of the triple header fishing lure 100 and its various components as shown in the FIGS. are for illustrative purposes only, and that many other sizes and shapes of the triple header fishing lure 100 are well within the scope of the present disclosure. Although the dimensions of the triple header fishing lure 100 are important design parameters for user convenience, the triple header fishing lure 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing lure system comprising:
a wire having a first arm and a second arm, wherein the second arm is disposed at an angle relative to the first arm;
a first fish mold removably connected to the first arm and having an LED feature;
a second fish mold removably connected to the first arm and having the LED feature;
a third fish mold removably connected to the first arm and having the LED feature;
at least one spinner blade attached to each of the first fish mold, the second fish mold and the second arm via a swivel; and
at least one hook connected to the third fish mold.

2. The fishing lure system as recited in claim 1, wherein the angle is between 75 and 120 degrees.

3. The fishing lure system as recited in claim 1, wherein the angle is 90 degrees or less.

4. The fishing lure system as recited in claim 1, wherein the wire has a diameter ranging from 0.012″ to 0.05″.

5. The fishing lure system as recited in claim 1, wherein the at least one hook is one of a bait holder hook, a siwash hook, an aberdeen hook, a circle hook, an octopus hook, a king Kahle hook, a shiner hook, a treble hook and a worm hook.

6. The fishing lure system as recited in claim 1, wherein each of the first and second fish molds create a turbulence for the at least one spinner attached thereto.

7. The fishing lure system as recited in claim 1, wherein each of the first and second fish molds have a fiber optic fiber extending outwardly therefrom.

8. The fishing lure system as recited in claim 1, wherein the hook is comprised of one of a high-carbon steel, a steel alloyed with vanadium, a stainless steel or a combination thereof.

9. The fishing lure system as recited in claim 1, wherein the LED feature can be set to flash intermittently or to remain illuminated.

10. The fishing lure system as recited in claim 1, wherein the second are comprises a second blade.

11. A method of using a fishing lure system comprising the steps of:
providing a fishing lure comprised of a wire having a first arm and a second arm, a first fish mold, a second fish mold, a third fish mold, a plurality of spinner blades and at least one hook, wherein each of the first second and third fish molds are removably attached to the first arm, and further wherein the second arm is disposed at an angle relative to the first arm;
placing the fishing lure on an end of a fishing line connected to a fishing pole; and
moving the fishing lure through a body of water to simulate a school of bait fish.

12. The method of using a fishing lure system of claim 11, wherein each of the first, second and third fish molds comprise an LED feature, and further wherein at least one of the plurality of spinner blades is attached to each of the first fish mold, the second fish mold and the second arm via a swivel.

13. The method of using a fishing lure system of claim 11, wherein the step of moving the fishing lure through the water causes the fishing lure to move in a three dimensional manner.

14. The method of using a fishing lure system of claim 13, wherein the angle is 90 degrees or less.

15. The method of using a fishing lure system of claim 11, wherein each of the first and second fish molds produce a turbulence for a spinner attached to each of the first and second fish molds.

16. A fishing lure comprising:
a plurality of fish molds connected to a wire; wherein each of the plurality of fish molds have an LED feature;
at least one spinner blade attached to at least one of the plurality of fish molds by a swivel;
a hook connected to at least one of the plurality of fish molds; and
a spinner bait skirt attached to at least one of the plurality of fish molds.

17. The fishing lure of claim 16, wherein the wire further comprises a first arm and a second arm separated from the first arm via an angle.

18. The fishing lure of claim 17, wherein the angle is between 75 and 120 degrees.

19. The fishing lure of claim 17, wherein the plurality of fish molds are positioned along the first arm in a spaced apart manner.

20. The fishing lure of claim 17 further comprising at least two spinner blades attached to the second arm.
